(19) United States
(12) Patent Application Publication
(10) Pub. No.: US 2017/0046970 A1
(43) Pub. Date: Feb. 16, 2017

(54) DELIVERING LITERACY BASED DIGITAL CONTENT

(71) Applicant: International Business Machines Corporation, Armonk, NY (US)

(72) Inventors: Su Liu, Austin, TX (US); Vi T. Tran, Austin, TX (US); Virginia A. Wigginton, Hutto, TX (US); Cheng Xu, Beijing (CN)

(21) Appl. No.: 14/823,620

(22) Filed: Aug. 11, 2015

(51) Int. Cl. G09B 17/00; G09B 5/00

(52) U.S. Cl. CPC G09B 17/003; G09B 17/00; G09B 5/00

(57) ABSTRACT

A computer system can receive a request for a user corresponding to a user profile to access a first digital content. Based upon the user profile, a literacy level for the user can be determined at the computer system. Based upon the first digital content, a literacy level for the first digital content can be determined at the computer system. In response to determining a difference between the literacy level for the user and the literacy level for the first digital content, a second digital content corresponding to the literacy level for the user and related to the first digital can be generated for display on a user interface.

### BACKGROUND

The present disclosure relates generally to dynamic content processing, and more particularly, to delivering literacy based digital content. On the Internet, digital content can be targeted towards users with specific literacy levels. However, the variance of literacy levels for users of the internet can make understanding digital content easier for some users and harder for others.

### SUMMARY

Aspects of the disclosure provide a computer-implemented method, computing device, and computer program product for delivering literacy based digital content. For example, in one embodiment, the method comprises receiving a request at a computer system for a user to access a first digital content. The user can correspond to a user profile. Based upon the user profile, a literacy level for the user can be determined at the computer system. Based upon the first digital content, a literacy level for the first digital content can be determined at the computer system. In response to determining a difference between the literacy level for the user and the literacy level for the first digital content, a second digital content relating to the first digital content and corresponding to the literacy level for the user can be generated for display on a user interface.

The above summary is not intended to describe each illustrated embodiment or every implementation of the present disclosure.

### BRIEF DESCRIPTION OF THE DRAWINGS

The drawings included in the present application are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 depicts a block diagram of a system for delivering literacy based digital content, according to embodiments.

FIG. 2 depicts one embodiment of an example process for delivering literacy based digital content.

FIG. 3 depicts one embodiment of an example process for determining a literacy level for a user.

FIG. 4 depicts one embodiment of an example process for generating a second digital content.

FIG. 5 depicts a cloud computing node, according to embodiments.

FIG. 6 depicts a cloud computing environment, according to embodiments.

FIG. 7 depicts abstraction model layers, according to embodiments.

While the embodiments described herein are amenable to various modifications and alternative forms, specifics thereof have been shown by way of example in the drawings and will be described in detail. It should be understood, however, that the particular embodiments described are not to be taken in a limiting sense. On the contrary, the intention is to cover all modifications, equivalents, and alternatives falling within the spirit and scope of the invention.

### DETAILED DESCRIPTION

Aspects of the present disclosure relate generally to dynamic content processing, and more particular aspects relate to delivering digital content based on literacy levels. While the present disclosure is not necessarily limited to such applications, various aspects of the disclosure can be appreciated through a discussion of various examples using this context.

Literacy has traditionally been understood as the ability to read and write. The term's meaning has been expanded to include the ability to use language, numbers, images and other means to understand and use the dominant symbol systems of a culture. Literacy represents the lifelong, intellectual process of gaining meaning from a critical interpretation of written or printed text. The key to literacy is reading development, a progression of skills that begins with the ability to understand spoken words, decode written words, and culminates in the understanding of text.

In the United States, many non-native and even native English speakers seek to learn the English language as part of a school curriculum or simply to increase their ability to function in society. According to a study conducted by the U.S. Department of Education and the National Institute of Literacy in April 2013, 32 million adults in the United States can't read English, a percentage of 14% of the population. Additionally, in the same study, it was determined that 21% of the adults (ages 16 and over) read below a 5^{th} grade level, and 19% of high school graduates can't read at all.

When users read on the Internet, research has shown that the majority of users scan content they come across and pick out the pieces that interest them. In contrast, users with a low reading ability (i.e., lower literacy) can read, but often take longer or have difficulty understanding multi-syllabic words. The most notable difference between lower and higher literacy users is that lower-literacy users can't understand a text by glancing at it. Rather, lower literacy users read content word-by-word and often spend a considerable amount of time doing so. As soon as text becomes too dense, lower literacy users skip content and can often overlook important information. This is especially true for non-English speakers in the United States, where a lower literacy level can prevent non-English speaking users from understanding vital messages, such as personal health information, insurance options, or medicine descriptions.

Aspects of the present disclosure provide a method for delivering literacy based digital content. The method can include receiving a request at a literacy assessment application hosted by a computer system for a user to access a first digital content. In various embodiments, a literacy assessment application can be a software application which can send, receive, and/or modify digital content. As used herein, “to modify” can be used as shorthand for “to add, to delete, to insert, to remove, to refresh, to revise, to update, and/or to alter.” In certain embodiments, digital content can include audio data (e.g., audible content, intonation, pitch), image data (e.g., photographs), video data (e.g., recorded camera footage), or textual data (e.g., message board posts, news articles). In some embodiments, the user can correspond to a user profile.

Based upon the user profile, a literacy level for the user can be determined. In various embodiments, the literacy assessment application can be used to determine the literacy level for the user. As used herein, a literacy level can be defined as a measurement of the ability of a user to read, write, spell, listen, and speak. For example, a literacy level can be expressed in United States (US) educational grade levels (e.g., 8^{th} grade). In various embodiments, determining the literacy level for the user can include collecting historical data of the user from social network repositories. Historical data can include digital content created by the user. For example, historical data can include digital content shared by a user on a social network forum (e.g., news articles, videos, content written by user), user information displayed on a social network forum (e.g., education history, employment history, personal information), and/or contents of email or an instant messaging service from an Intranet.

In some embodiments, historical data can also include the digital content viewed by a user on the Internet. For example, the browsing history of a user on the Internet may be used to collect digital content viewed by the user. In certain embodiments, social network repositories can be a location (e.g., servers) where digital content inputted by users belonging to the social network is stored and can be accessible to the computer-implemented method. A social network can include an online networking service where users share digital content and communicate with one another.

Based upon the historical data of the user, the literacy level for the user can be determined, discussed further herein. In various embodiments, determining the literacy level for the user can include utilizing readability tests, such as, but not limited to, the Flesch/Flesch-Kincaid readability tests, on the historical data of the user. In response to determining the literacy level for the user, the user profile can be updated with the results of the literacy level for the user. In some embodiments, the user profile can include the historical data collected from the repositories of social networks as well as previous user literacy level assessments performed. In certain embodiments, the literacy level for the user can be recalculated and updated dynamically as new historical data is collected. In various embodiments, the user profile can include a plurality of literacy levels determined for a user for specific content. For example, a user may have a first literacy level for sports topics and a second literacy level for science topics. The user profile can be stored in a literacy level database. In some embodiments, the literacy level database can be a location (e.g., servers) where user profiles as well as collected historical data are stored.

Based upon the first digital content, a literacy level for the first digital content can be determined at the literacy assessment application. Determining the literacy level for the first digital content can include utilizing readability tests (e.g., Flesch/Flesch-Kincaid) on the first digital content. Once the literacy level for the first digital content has been determined, the literacy level for the user can be compared with the literacy level of the first digital content. In response to determining a difference between the literacy level for the user and the literacy level for the first digital content, a second digital content can be generated for display on a user interface. For example, a first digital content can correspond to a US grade level of 9^{th} grade whereas the literacy level for the user can correspond to a US grade level of 8^{th} grade. In response to recognizing a difference in literacy levels, the second digital content can be generated. In various embodiments, the second digital content can correspond to the literacy level for the user. For instance, continuing the example above, the second digital content can be modified to correspond to a US grade level of 8^{th} grade.

In certain embodiments, generating the second digital content can include modifying the first digital content to conform to the literacy level for the user, discussed further herein. In response to modifying the first digital content, the second digital content can be analyzed by performing a syntax and semantic verification on the second digital content, discussed further herein. In response to performing the syntax and semantic verification, the second digital content can be delivered displayed on a user interface and/or stored in the literacy level database. In various embodiments, the literacy level database can be organized according to a readability index for the digital content. In some embodiments, a readability index can be an approximate representation of the US grade level needed to comprehend the text. As used herein, the terms “literacy level” and “readability index” may be used interchangeably.

In various embodiments, displaying the second digital content can include visually differentiating where the second digital content has been modified from the first digital content. For instance, words in the second digital content that have replaced words from the first digital content can be highlighted. In another example, the highlighted words can include a hyperlink providing additional information to the user related to each respective word such as a dictionary definition or related words listed by a thesaurus.

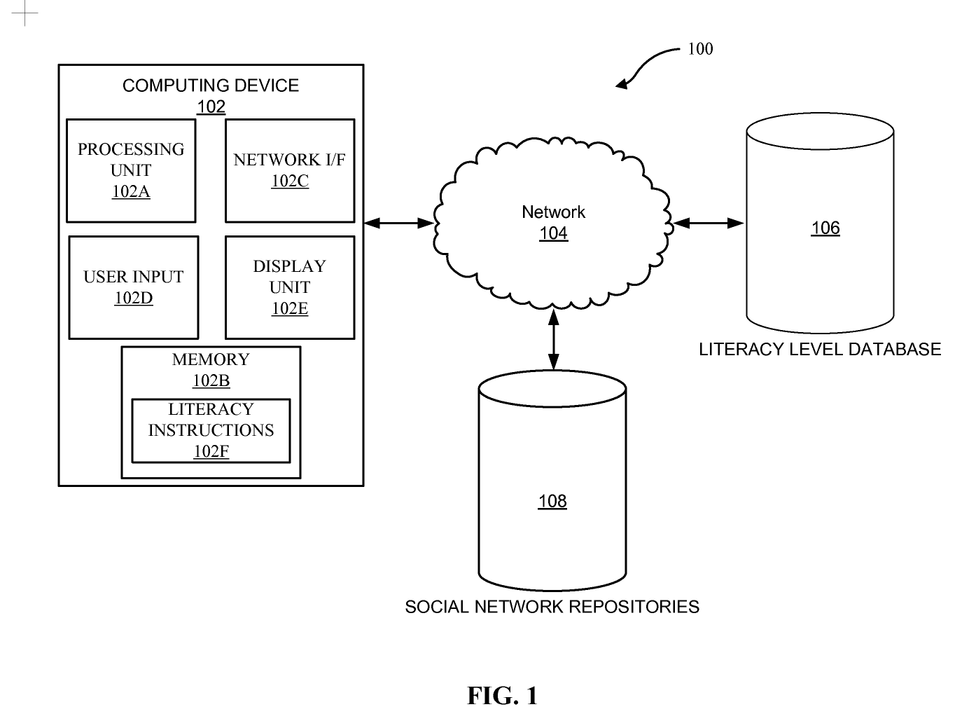

Referring now to the figures, FIG. 1 depicts a block diagram of a system 100 for delivering literacy based digital content, according to embodiments. The system 100 includes a computing device 102, a network 104, a literacy level database 106, and a plurality of social network repositories 108. In certain embodiments, the computing device 102 and the literacy level database 106 can be distant from each other and communicate over the network 104. In other embodiments, the computing device 102 and the literacy level database 106 can communicate with each other directly utilizing other communication mediums discussed herein. The computing device 102 can include a processing unit 102A, a memory 102B, a network interface (IF) 102C, a user input device 102D, and a display unit 102E.

In certain embodiments, the computing device 102 and the literacy level database 106 are located remote or distant from one another and the network 104 can be implemented by any number of any suitable communications media (e.g., wide area network (WAN), local area network (LAN), Internet, Intranet, etc.). Alternatively, the computing device 102 and the literacy level database 106 can be local to each other, and communicate via any appropriate local communication medium (e.g., local area network (LAN), hardwire, wireless link, Intranet, etc.). In certain embodiments, the network 104 can be implemented within a cloud computing environment, or using one or more cloud computing services. Consistent with various embodiments, a cloud computing environment can include a network-based, distributed data processing system that provides one or more cloud computing services. In certain embodiments, a cloud computing environment can include many computers, such as, but not limited to, hundreds or thousands of them, disposed within one or more data centers and configured to share resources over the network.

The processing unit 102A can execute the literacy instructions 102F stored in the memory 102B. In certain embodiments, the processing unit 102A can communicate with other components within the computing device 102, such as the user input device 102D and the display unit 104E, in order to execute the literacy instructions 102F stored within the memory 102B. The processing unit 102A can include various types of processors such as, digital signal processor (DSP) hardware, network processor, application specific integrated circuit (ASIC), field programmable gate array (FPGA), or other types of processors. The memory 102B can be coupled to the processing unit 102A via a memory bus, for example. In various embodiments, the literacy instructions 102F are configured, when executed by the processing unit 102A, to perform one or more of the functions described herein for delivery of literacy based digital content.

The memory 102B can include a random-access semiconductor memory, storage device, or storage medium (either volatile or non-volatile) for storing or encoding data and programs. The memory 102B can be conceptually a single monolithic entity, but in some embodiments, the memory 102B can be a more complex arrangement, such as a hierarchy of caches and other memory devices. The memory 102B can store data, instructions, modules, application software and other types of information. In some embodiments, the memory 102B can be on a separate computing device (not shown) and can be accessed remotely, e.g., via the network 104.

The network I/F 102C can utilize, for example, shortwave, high frequency, ultra-high frequency, microwave, wireless fidelity (Wi-Fi), Bluetooth technology, global system for mobile communications (GSM), code division multiple access (CDMA), second-generation (2G), third-generation (3G), fourth-generation (4G), or any other wireless communication technology or standard to establish a wireless communications link between the computing device 102 and the literacy level database 106.

The user input device 102D can include input devices including but not limited to a keyboard, mouse, scanner or similar device. In various embodiments, the user input device 102D can include any commercially available or custom software such as browser software, communications software, server software, natural language processing software, search engine and/or web crawling software, filter modules for filtering content based upon predefined parameters, and the like. The display unit 102E can include display devices, such as computer screens or display monitors. The computing device 102 can utilize instructions stored on the memory 102B or input received from the user input device 102D to cause the processing unit 102A to perform the computer-implemented method discussed herein and output the results through the display unit 102E.

The literacy level database 106 can be used to store user profiles created by the computing device 102. In certain embodiments, the literacy level database 106 can be used to store digital content. Storing the digital content can include the first digital content requested by a user as well as the second digital content generated in response to determining a difference in literacy levels between the user profile and the first digital content. The user profiles can be stored in the literacy level database 106 according to user literacy levels. For instance, the user profiles associated with a US grade level of 8^{th} grade would be grouped together while the user profiles associated with a US grade level of 5^{th} grade would be grouped together. In certain embodiments, the digital content stored within the literacy level database 106 can be organized according to literacy level. For example, digital content with a US grade level of 8^{th} grade on the subject matter of sports can be separated from digital content with a US grade level of 5^{th} grade on the subject matter of sports. In further embodiments, the literacy level database 106 can include a plurality of sub-databases. Each sub-database within the literacy level database 106 can store a different type of digital content (e.g., textual digital content, first digital content, second digital content).

The user profiles stored in the literacy level database 106 can be updated each time a user requests a first digital content. In some embodiments, a progression record of user literacy levels can be kept to be used to determine the modification required for the first digital content without having to analyze the user profile as well as to monitor the literacy level of the user. In other embodiments, a frequency record can be kept for the digital content stored in the literacy level database 106. The frequency record can be used to keep digital content frequently requested by multiple users with similar literacy levels and to remove digital content seldom requested or used. For example, if a first user requests a first digital content and a second digital content is generated to correspond to the literacy level of the first user, and a second user requests the same first digital content with a literacy level similar to the literacy level of the first user, the frequency record would note that multiple users have requested the same first digital content and without having to modify the first digital content twice, the second digital content corresponding to the literacy level of the first user can be provided to the second user with little to no delay associated with generating the second digital content.

The social network repositories 108 can be locations (e.g., servers) where digital content inputted by users belonging to the social network is stored and can be accessible to the processing unit 102A performing the computer-implemented method. A social network can include an online networking service where users share digital content and communicate with one another. Digital content from the social network repositories 108 can be accessed by and/or transmitted to the computing device 102 and/or the literacy level database 106 through the network 104.

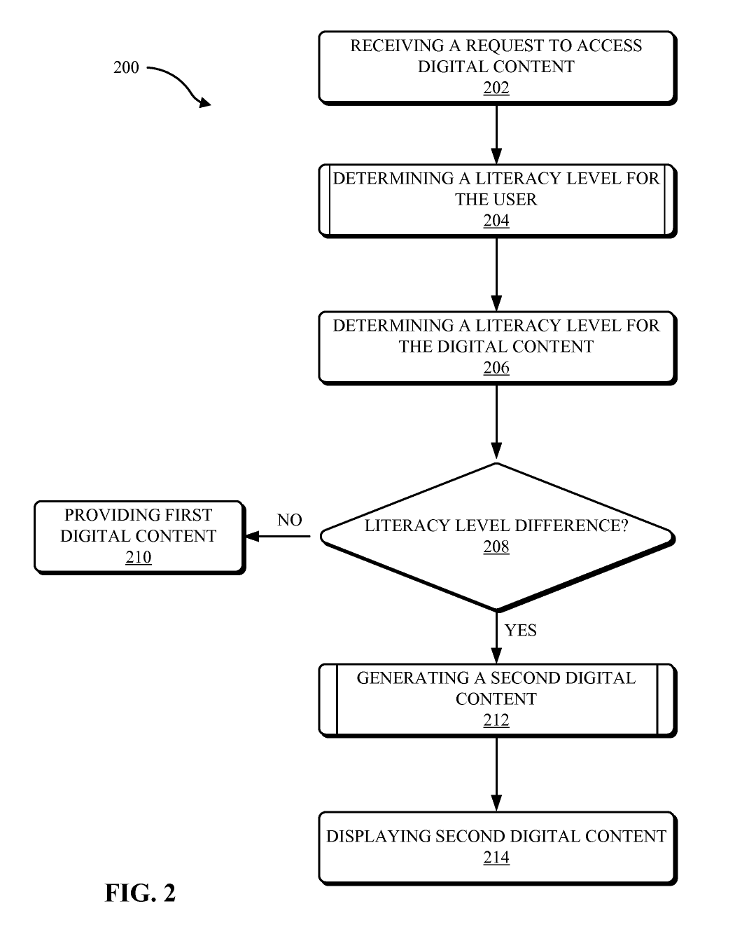

FIG. 2 depicts one embodiment of an example process 200 for delivering literacy based digital content. It is to be understood that the order in which the blocks described below are discussed is not to be construed as limiting the order in which the individual acts may be performed. In particular, the acts performed may be performed simultaneously or in a different order than that discussed. In various embodiments, one or more of the acts described with respect to the process 200 can be implemented via a processor executing instructions stored on a computer readable medium, such as the literacy instructions 102F discussed above with respect to FIG. 1.

The process 200 can begin at block 202 where a request is received at a computing device to access a first digital content. In various embodiments, receiving a request to access a first digital content can include retrieving the first digital content from a database, such as the literacy level database 106 discussed in FIG. 1. In other embodiments, receiving a request to access a first digital content can include retrieving the first digital content from the Internet, such as content provided on social networks stored in repositories, such as the social network repositories 108 discussed in FIG. 1. In certain embodiments, retrieving the first digital content can include utilizing the application programming interfaces (API) of websites hosting digital content. In further embodiments, the APIs can be cloud APIs.

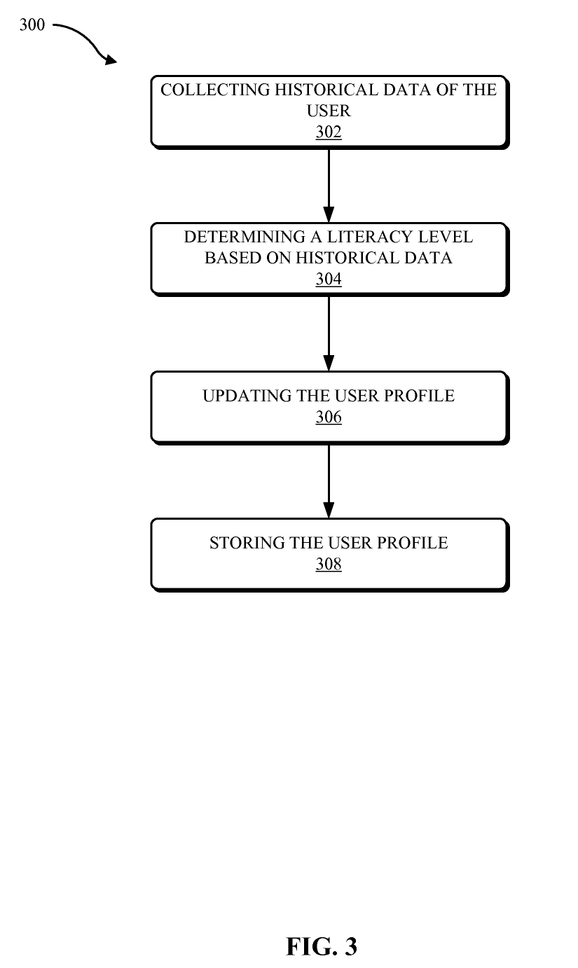

At block 204, a literacy level for the user is determined. One example of determining a literacy level for the user is discussed in more detail with respect to FIG. 3.

At block 206, a literacy level for the digital content is determined. In embodiments, determining the literacy level for the digital content can include utilizing a natural language processing technique configured to analyze syntactic and semantic content. The natural language processing technique can be configured to parse structured data (e.g., tables, graphs) and unstructured data (e.g., textual content containing words, numbers, symbols). In certain embodiments, the natural language processing technique can be a software tool or other program configured to analyze and identify the semantic and syntactic elements and relationships present in the digital content. More particularly, the natural language processing technique can be configured to parse the grammatical constituents, parts of speech, context, and other relationships (e.g., modifiers) of the digital content. The natural language processing technique can be configured to recognize keywords, contextual information, and metadata tags associated with words, phrases, or sentences for a subject matter topic. In certain embodiments, the natural language processing technique can analyze summary information, keywords, figure captions, or text descriptions included in the presentation data, and identify syntactic and semantic elements for a concept. The syntactic and semantic elements can include information such as word frequency, word meanings, text font, italics, hyperlinks, proper names, noun phrases, parts-of-speech, or the context of surrounding words. Other syntactic and semantic elements are also possible. In some embodiments, natural language processing can include speech (e.g., audio/video data) to text (e.g., textual data) conversions.

In other embodiments, the Flesch/Flesch-Kincaid readability tests or similar assessment methods known to those skilled in the art can be used to determine the literacy level for the digital content. In certain embodiments, the literacy level for the digital content can be pre-determined. For example, after a web administrator/developer/user adds a new digital content into a web server where the new digital content includes metadata indicating what the literacy level is for the new digital content, the process 200 can collect the new digital content and store it in a literacy level database before the user requests to access the new digital content.

In some embodiments, the process 200 can monitor the digital content requested in order to create a corpus used in determining literacy levels for digital content. For example, each time a digital content is requested, the process 200 can analyze the digital content and record metrics such as the word frequency, the number of times the word starts with a capital or lower case letter, the total amount of sentences, and/or the total amount of syllables. The metrics can be used to compare a requested digital content with the metrics extracted from the digital content stored in the corpus to determine a literacy level for the digital content. For example, Table 1 shows example phrases from a car manual and their associated literacy level (e.g., grade level) based on a Flesch-Kincaid readability test method:

TABLE 1

| Sample Text | US Grade Level |
|---|---|
| BREAKDOWN SIGN LIGHT | 2 |
| CHECK ENGINER LIGHT | 5 |
| FAILURE SIGN LIGHT | 5 |
| MALFUNCTION SIGN LIGHT | 6 |
| DEFECT INDICATOR LAMP | 6 |
| GLITCH INDICATOR LAMP | 9 |
| MALFUNCTION INDICATOR LAMP | 10 |

At block 208, the literacy level for the user is compared with the literacy level for the requested first digital content. If the literacy level for the user corresponds with the literacy level for the first digital content, the first digital content is provided for display on a user interface at block 210. In various embodiments, a threshold can define when the digital content is modified. For example, a threshold could be defined such that if the difference between the literacy level for the first digital content and the literacy level for the user are more than 2 US grade levels, then the first digital content can be modified into a second digital content. In certain embodiments, the threshold can be user defined. In further embodiments, the threshold can be defined by an API.

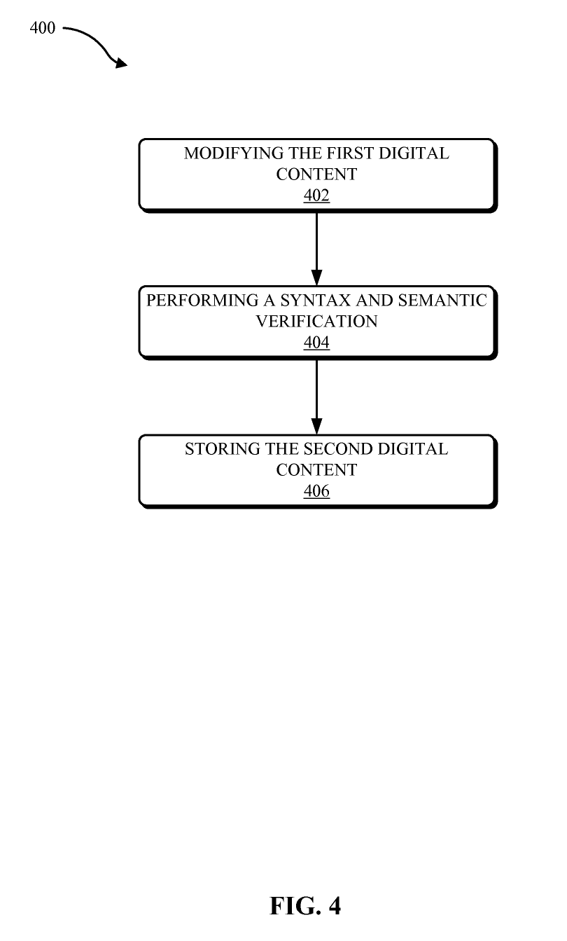

If the literacy level for the user does not correspond with the literacy level for the first digital content, a second digital content can be generated at block 212. One example of generating a second digital content is discussed in more detail with respect to FIG. 4.

In response to generating the second digital content, the second digital content is displayed on a user interface at block 214.

FIG. 3 depicts one embodiment of an example process 300 for determining a literacy level for a user. In various embodiments, one or more of the acts described with respect to the process 300 can be implemented via a processor executing instructions stored on a computer readable medium, such as the literacy instructions 102F discussed above with respect to FIG. 1.

The process 300 can begin at block 302 where historical data of the user is collected. In some embodiments, historical data can be digital content used to help determine the literacy level for the user. In various embodiments, collecting historical data of the user can include accessing social networks the user belongs to. In further embodiments, the user profile can contain login information to be able to access the social networks the user belongs to. The historical data can be collected using APIs, web crawlers, or similar content retrieval techniques known to those skilled in the art. In some embodiments, collecting historical data can include accessing the browsing history of the user, retrieving and downloading the content viewed by the user, and storing the downloaded content in a database for processing, such as the literacy level database 106 discussed in FIG. 1.

At block 304, a literacy level based on historical data is determined for the user. In various embodiments, determining the literacy level for the user can include implementing natural language processing as well as the Flesch/Flesch-Kincaid readability tests or similar literacy level assessment methods known to those skilled in the art to analyze the historical data collected at block 302. For example, if historical data stored in the literacy level database under the profile of a first user includes information such as a birthdate, educational background, or employment information, natural language processing techniques and/or literacy level assessments could analyze that information to determine a baseline literacy level (e.g., an initial literacy level determination for the user without analyzing content written by the user). For example, based upon the estimated age of the user, a literacy level can be determined.

In another example, if the first user profile includes educational information and/or employment information, the process 300 can search for additional user profiles stored in the literacy level database which include similar educational information, such as attending the same university or similar employment information, such as working for the same company or working in the same field. If the additional user profile includes a literacy level, the literacy level from the additional user profile can then be used to establish a baseline literacy level for the first user. In a further example, if the educational information includes degrees obtained by the user, such as a master's degree in mechanical engineering (M.E.) or a PhD in philosophy, natural language processing techniques can extract this information and utilize both the field of the degree (e.g., M.E. vs. philosophy) as well as the type/level of the degree (e.g., masters vs PhD) to assign a baseline literacy level for the user. In other embodiments, a user can be assigned different literacy levels for separate subject matters, such as a first literacy level for mechanical engineering and a second literacy level for philosophy.

In another example, content viewed by the user can be analyzed to determine a literacy level corresponding to the viewed content. For instance, a web crawler may collect and download digital content viewed by the user, analyze the downloaded digital content to determine a literacy level for each downloaded digital content, and average the literacy levels for each of the downloaded digital content to create a baseline literacy level. In certain embodiments, the baseline literacy level can be updated based upon digital content created by the user. For example, original posts to a social networking service (e.g., content written by the user), email communications, and/or instant messaging transcripts can be analyzed by a literacy level assessment method, and assigned a literacy level.

At block 306, the user profile is updated at the literacy level database with the results obtained at block 304. In certain embodiments, the literacy level for the user can dynamically update each time the process 300 determines a literacy level for the user, as described at Block 304. For example, when a literacy level is determined for the user based upon the digital content viewed by the user, the literacy level from the digital contents can be supplement the baseline literacy level in the user profile to determine an up to date literacy level for the user profile.

At block 308, the user profile is stored in the literacy level database (e.g., the literacy level database 106 discussed in FIG. 1). In various embodiments, storing the user profile in the literacy level database can include organizing user profiles according to the determined literacy level for the user. In some embodiments, the determined literacy levels for the user can be used to store user profiles according to subject matter. For example, a user profile with a first literacy level for sports may be sorted and grouped with similar user profiles with similar literacy levels for sports whereas a user profile with a second literacy level for politics may be sorted and grouped with similar user profiles with similar literacy levels for politics.

In certain embodiments, storing the user profile can include storing the digital content used to determine the literacy level for the user in the user profile. In further embodiments, storing the digital content can include organizing the digital content according to a readability index. For example, digital content with a US grade level of 8^{th} grade can be grouped together while digital content with a US grade level of 6^{th} grade can be grouped together. In various embodiments, the digital content stored within the literacy level database can include the digital content collected from the historical data as well as the digital content modified for the literacy level for the user.

FIG. 4 depicts one embodiment of an example process for generating a second digital content. In various embodiments, one or more of the acts described with respect to the process 400 can be implemented via a processor executing instructions stored on a computer readable medium, such as the literacy instructions 102F discussed above with respect to FIG. 1.

The process 400 can begin at block 402 where the first digital content is modified. In various embodiments, modifying the first digital content can include utilizing a segmentation software application. In some embodiments, the segmentation software application can utilize the determined literacy levels for the digital content (discussed in FIG. 2) and for the user (discussed in FIG. 3) to analyze and replace each word, abbreviation, phrase or sentence based on the literacy levels for the digital content and for the user. In various embodiments, the segmentation software application can be applied to languages which do not have a natural word separator (e.g., the English language uses a space), such as Chinese, Japanese, or Korean languages.

For example, a user can be been determined to have a literacy level corresponding to a US grade level of 5th grade and requests to read an online car manual (e.g., digital content in the form of textual data). The online car manual can be downloaded, stored within the literacy level database, and analyzed by natural language processing and/or literacy level assessment methods to determine a literacy level for the online car manual. Continuing the example, the online car manual can be determined to have a literacy level corresponding to a US grade level of 10^{th} grade. In response to determining a difference between the literacy level for the user and the literacy level for the car manual, the segmentation software application discussed in block 402 can modify the first digital content to correspond to the literacy level for the user. For example, the phrase “malfunction indicator lamp”, which has a literacy level corresponding to a US grade level of 10^{th} grade can be replaced with the phrase “check engine light”, which has a literacy level corresponding to a US grade level of 5^{th} grade (i.e., the literacy level for the user).

In another example, a user can request to view a video documentary (e.g., video data). The documentary can be downloaded, stored within the literacy level database, and analyzed by natural language processing to extract a transcript out from the video data. The transcript can then be analyzed by natural language processing and/or literacy level assessment methods to determine a literacy level for the transcript of the video data. In response to determining a difference between the literacy level for the user and the literacy level for the transcript, the transcript can be modified to correspond to the literacy level for the user. When the transcript has been modified, it can be generated into subtitles to be overlaid within the video documentary.

In other embodiments, modifying the first digital content can include visually differentiating where the second digital content has been modified from the first digital content. For example, words in the second digital content that have replaced words from the first digital content can be highlighted to include hyperlinks which can provide the user additional information, such as digital content previously stored in the literacy level database.

At block 404, a syntax and semantic verification is performed on the second digital content generated by modifying the first digital content at block 402. For instance, continuing the example above where a user with a literacy level corresponding to a US grade level of 5th grade requests to read an online car manual with the phrase “malfunction indicator lamp”, the operation performed at block 402 can include generating a plurality of alternative phrases, such as “wrong sign light”, “bad sign light”, “failed sign light”, and “failure sign light.” Utilizing the syntax and semantic verification, the process 400 can determine that “failed sign light” is better than “failure sign light” according to syntax rules. Further, the process 400 can determine that “wrong sign light” and “bad sign light” are not ideal phrases given the context of the digital content. The syntax and semantic verification can be performed by the natural language processing techniques discussed above. In various embodiments, the syntax and semantic verification can be an optional process. In some embodiments, a user can define when verification is performed (e.g., what difference in literacy levels between the digital content and the user is required) and the kind of digital content subject matter the syntax and semantic verification is performed upon, such as only for medical digital content.

At block 406, the second digital content generated at block 402 can be stored in the literacy level database. In some embodiments, the second digital content can be stored with the first digital content based upon subject matter. In other embodiments, the second digital content can be stored within the user profile.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model can include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but can be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It can be managed by the organization or a third party and can exist on-premises or off-premises.

Community cloud: the cloud infrastructure is shared by several organizations and supports a specific community that has shared concerns (e.g., mission, security requirements, policy, and compliance considerations). It can be managed by the organizations or a third party and can exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

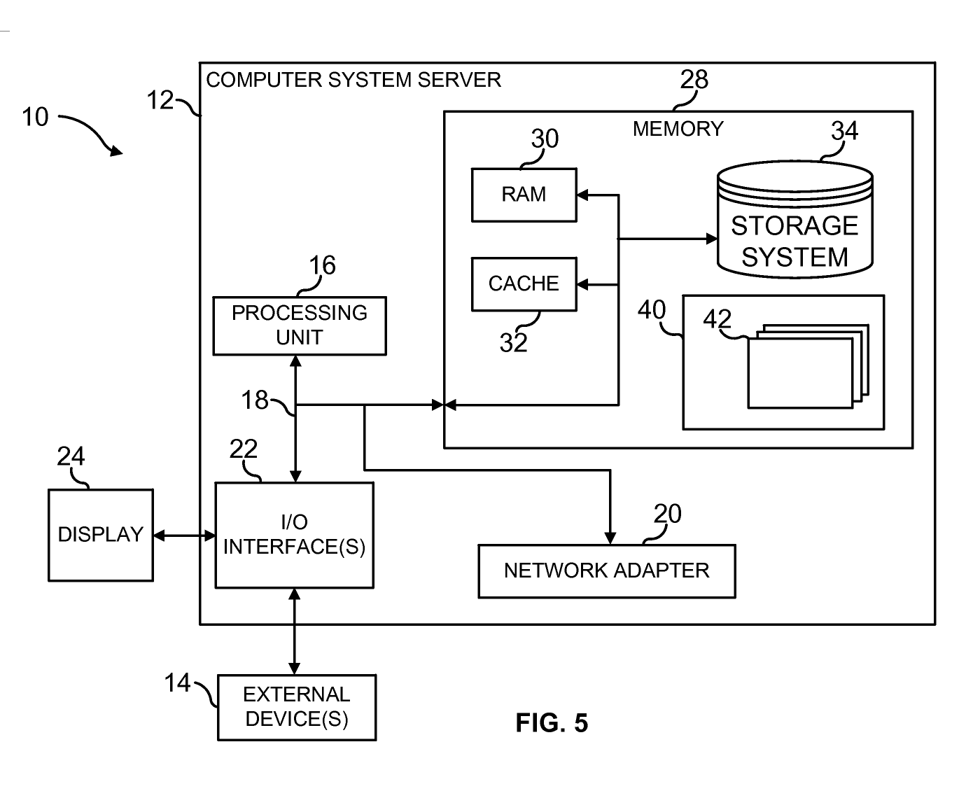

Referring now to FIG. 5, a schematic of an example of a cloud computing node is shown. Cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that can be suitable for use with computer system/server 12 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 can be described in the general context of computer system-executable instructions, such as program modules, being executed by a computer system. Generally, program modules can include routines, programs, objects, components, logic, data structures, and so on that perform particular tasks or implement particular abstract data types. Computer system/server 12 can be practiced in distributed cloud computing environments where tasks are performed by remote processing devices that are linked through a communications network. In a distributed cloud computing environment, program modules can be located in both local and remote computer system storage media including memory storage devices.

As shown in FIG. 5, computer system/server 12 in cloud computing node 10 is shown in the form of a general-purpose computing device. The components of computer system/server 12 can include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12 typically includes a variety of computer system readable media. Such media can be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 can further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 can include at least one program product having a set (e.g., at least one) of program modules that are configured to carry out the functions of embodiments of the invention.

Program/utility 40, having a set (at least one) of program modules 42, can be stored in memory 28 by way of example, and not limitation, as well as an operating system, one or more application programs, other program modules, and program data. Each of the operating system, one or more application programs, other program modules, and program data or some combination thereof, can include an implementation of a networking environment. Program modules 42 generally carry out the functions and/or methodologies of embodiments of the invention as described herein.

Computer system/server 12 can also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/0) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, external disk drive arrays, RAID systems, tape drives, and data archival storage systems, etc.

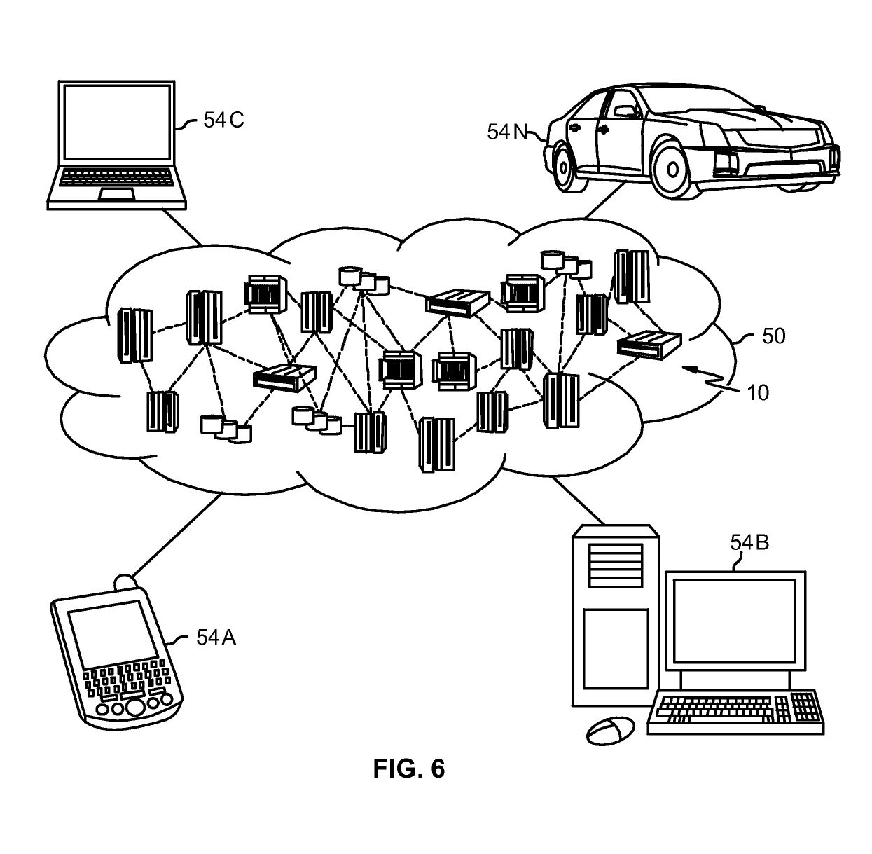

Referring now to FIG. 6, illustrative cloud computing environment 50 is depicted. As shown, cloud computing environment 50 comprises one or more cloud computing nodes 10 with which local computing devices used by cloud consumers, such as, for example, personal digital assistant (PDA) or cellular telephone 54A, desktop computer 54B, laptop computer 54C, and/or automobile computer system 54N can communicate. Nodes 10 can communicate with one another. They can be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 2 are intended to be illustrative only and that computing nodes 10 and cloud computing environment 50 can communicate with any type of computerized device over any type of network and/or network addressable connection (e.g., using a web browser).

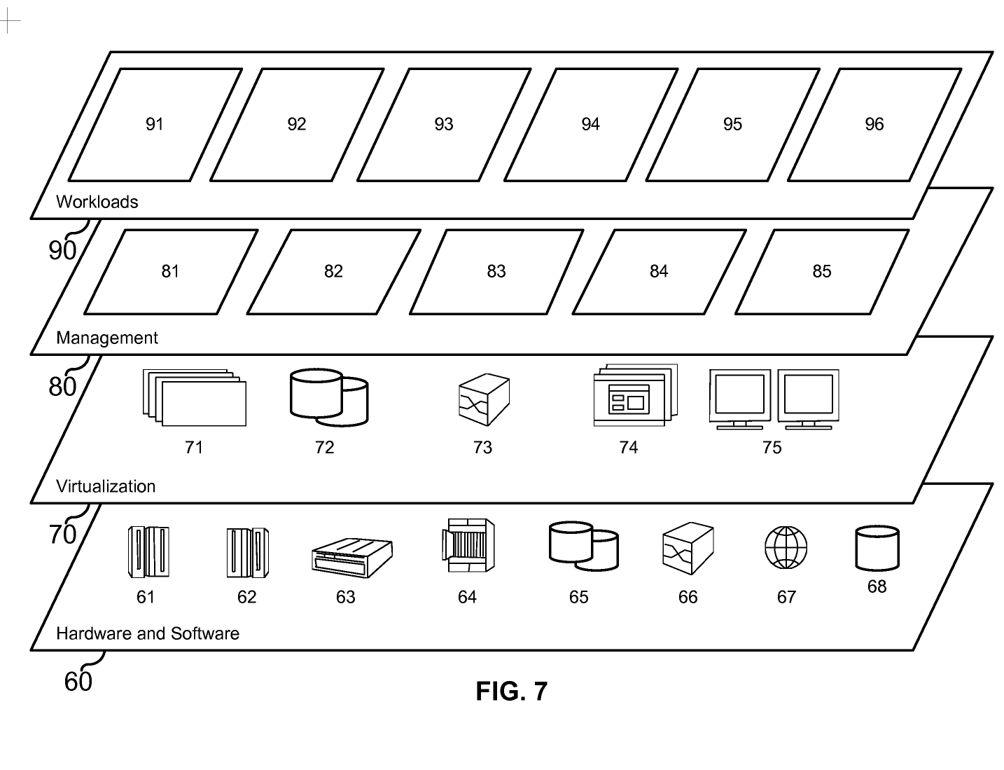

Referring now to FIG. 7, a set of functional abstraction layers provided by cloud computing environment 50 (FIG. 4) is shown. It should be understood in advance that the components, layers, and functions shown in FIG. 5 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities can be provided: virtual servers 71; virtual storage 72; virtual networks 73, including virtual private networks; virtual applications and operating systems 74; and virtual clients 75. In embodiments, the virtualization layer 70 can be used to connect a mobile device (e.g., mobile device 102) with a wearable device (e.g., wearable device 104).

In one example, management layer 80 can provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources can comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment can be utilized. Examples of workloads and functions which can be provided from this layer include: mapping and navigation 91; software development and lifecycle management 92; virtual classroom education delivery 93; data analytics processing 94; transaction processing 95; and literacy instructions 96. The literacy instructions 96 can be configured to cause a processor to determine literacy levels for digital content. Determining literacy levels for digital content can include determining literacy levels for digital content generated by a user. The literacy instructions 96 can include storing the results from the literacy level determinations in a literacy level database.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

What is claimed is:

1. A computer-implemented method for delivering literacy based digital content, the method comprising:
receiving a request at a computer system for a user to access a first digital content, wherein the user corresponds to a user profile;
determining at the computer system, based upon the user profile, a literacy level for the user;
determining at the computer system, based upon the first digital content, a literacy level for the first digital content; and
in response to determining a difference between the literacy level for the user and the literacy level for the first digital content, generating a second digital content related to the first digital content for display on a user interface, wherein the second digital content corresponds to the literacy level for the user.

2. The method of claim 1, wherein each of the first digital content and the second digital content comprises at least one of: audio data, image data, video data, or textual data.

3. The method of claim 1, wherein determining the literacy level for the user comprises:
collecting historical data of the user from social network repositories, wherein the user profile includes historical data;
determining, based upon the historical data of the user, the literacy level for the user;
updating the user profile based upon the determined literacy level for the user; and
storing the user profile in a literacy level database.

4. The method of claim 1, wherein generating the second digital content further comprises:
modifying the first digital content to conform to the literacy level for the user;
performing a syntax and semantic verification on the second digital content; and
storing, in response to performing the syntax and semantic verification, the second digital content in the literacy level database, wherein the literacy level database is organized according to a readability index.

5. The method of claim 1, wherein displaying the second digital content includes visually differentiating where the second digital content is modified from the first digital content.

6. The method of claim 1, wherein the user profile contains at least two literacy levels for different subject matters.

7. A computing device for delivering literacy based digital content comprising:
a memory;
a user input device configured to receive a request from a user to access a first digital content;
a network interface configured to communicatively couple the computing device to a literacy level database;
a display unit configured to display digital content to the user;
a processor coupled to the memory, the user input device, the display unit, and the network interface;
wherein the processor is configured to determine a literacy level for the user based upon a user profile corresponding to the user;
wherein the processor is further configured to retrieve the first digital content via the network interface and to determine, based upon the first digital content, a literacy level for the first digital content;
wherein the processor is further configured to generate a second digital content corresponding to the literacy level for the user based on the first digital content in response to determining a difference between the literacy level of the user and the literacy level of the first digital content;
wherein the processor is configured to send the second digital content via the network interface to the literacy level database for storage; and
wherein the processor is configured to provide the second digital content to the display unit for display to the user.

8. The computing device of claim 7, wherein each of the first digital content and the second digital content comprises at least one of: audio data, image data, video data, or textual data.

9. The computing device of claim 7, wherein the processor is configured to determine the literacy level for the user by:
collecting historical data of the user from one or more social network repositories, wherein the user profile includes historical data;
determining, based upon the historical data of the user, the literacy level for the user;
updating the user profile based upon the determined literacy level for the user; and
storing the user profile in the literacy level database.

10. The computing device of claim 7, wherein generating the second digital content further comprises:
modifying the first digital content to conform to the literacy level for the user;
performing a syntax and semantic verification on the second digital content; and
storing, in response to performing the syntax and semantic verification, the second digital content in the literacy level database, wherein the literacy level database is organized according to a readability index.

11. The computing device of claim 7, wherein displaying the second digital content includes visually differentiating where the second digital content is modified from the first digital content.

12. The computing device of claim 7, wherein the user profile contains at least two literacy levels for different subject matters.

13. A computer program product for delivering literacy based digital content, the computer program product comprising a computer readable storage medium having program instructions embodied therewith, wherein the computer readable storage medium is not a transitory signal per se, the program instructions executable by a processor to cause the processor to perform a method comprising:
receiving a request at a computer system for a user to access a first digital content, wherein the user corresponds to a user profile;
determining at the computer system, based upon the user profile, a literacy level for the user;
determining at the computer system, based upon the first digital content, a literacy level for the first digital content; and
in response to determining a difference between the literacy level for the user and the literacy level for the first digital content, generating a second digital content related to the first digital content for display on a user interface, wherein the second digital content corresponds to the literacy level for the user.

14. The computer program product of claim 13, wherein each of the first digital content and the second digital content comprises at least one of: audio data, image data, video data, or textual data.

15. The computer program product of claim 13, wherein determining the literacy level for the user comprises:
collecting historical data of the user from social network repositories, wherein the user profile includes historical data;
determining, based upon the historical data of the user, the literacy level for the user;
updating the user profile based upon the determined literacy level for the user; and
storing the user profile in a literacy level database.

16. The computer program product of claim 13, wherein generating the second digital content further comprises:
modifying the first digital content to conform to the literacy level for the user;
performing a syntax and semantic verification on the second digital content; and
storing, in response to performing the syntax and semantic verification, the second digital content in the literacy level database, wherein the literacy level database is organized according to a readability index.

17. The computer program product of claim 13, wherein displaying the second digital content includes visually differentiating where the second digital content is modified from the first digital content.

18. The computer program product of claim 13, wherein the user profile contains at least two literacy levels for different subject matters.
